(19) United States
(12) Patent Application Publication
(10) Pub. No.: US 2022/0305905 A1
(43) Pub. Date: Sep. 29, 2022

(54) COMBINED FLUID TANK OBTAINED BY MEANS OF USAGE OF CORE IN CONICAL FORM IN ROTATIONAL METHOD AND THE PRODUCTION METHOD THEREOF

(71) Applicant: FLOTEKS PLASTIK SANAYI VE TICARET ANONIM SIRKETI, Bursa (TR)

(72) Inventors: Veysel Celal BEYSEL, Bursa (TR); Mehmet BEYSEL, Bursa (TR)

(73) Assignee: FLOTEKS PLASTIK SANAYI VE TICARET ANONIM SIRKETI, Bursa (TR)

(21) Appl. No.: 17/617,934

(22) PCT Filed: Aug. 28, 2020
(86) PCT No.: PCT/TR2020/050783

§ 371 Date: Dec. 10, 2021

(30) Foreign Application Priority Data
Dec. 10, 2019 (TR) 2019/19693

(51) Int. Cl. B60K 15/03; B60K 15/073

(52) U.S. Cl. CPC B60K 15/03177; B60K 15/073; B60K 2015/03493; B60K 2015/0344; B60K 2015/03046; B60K 2015/0775

(57) ABSTRACT

A combined fluid tank used in diesel engine vehicles using AdBlue is provided, wherein the AdBlue is a urea-based chemical and the combined fluid tank is manufactured using a rotation technology from a polymer-based material. The combined fluid tank includes a first chamber for diesel and a second chamber for AdBlue positioned next to the first chamber, a double-walled impermeable chamber constructed between the first chamber and the second chamber, and a baffle located in at least one of the first chamber and the second chamber and the baffle provides sound and vibration damping, and to a production method of the combined fluid tank.

### CROSS REFERENCE TO THE RELATED APPLICATIONS

This application is the national stage entry of International Application No. PCT/TR2020/050783, filed on Aug. 28, 2020, which is based upon and claims priority to Turkish Patent Application No. 2019/19693 filed on Dec. 10, 2019, the entire contents of which are incorporated herein by reference.

### TECHNICAL FIELD

The invention relates to a plastic tank developed to ensure that two different fluids are stored in a single tank with two chambers and/or a single chamber fluid tank without mixing with each other and reduce the noise and load effect caused by sloshing, and the production of this tank using rotation technology and a special core heating system designed for this purpose.

### BACKGROUND

Water tanks, fuel tanks, plastic canoes, traffic skates, and similar plastic products are produced by rotational molding. Rotational molding is a method in which the powdered material placed in a mold and heat is applied externally to the mold and rotated horizontally and vertically, and the material is melted and covered on the inner surface of the mold and then cooled to take the form of the mold. In this method, hollow, single-section products can be produced easily.

In this technique, it is difficult to produce two-part, non-transitional products. Likewise;
a) For such productions, the powder raw material put into the mold must circulate in both parts, and that is, it will be a problem if the sections are already closed before molding.
b) It is possible to wrap raw materials around the deep cores required for two-section products by heating the cores homogeneously at the level of the mold outer wall. This is not possible unless special precautions are taken.

Another problem is the strong vibration and inertial forces they are subjected to in case of road conditions, bends, braking, and acceleration when such two-section products are used as fuel tanks in vehicles. Many conventional plastic tanks cannot withstand these conditions. Placing baffles in the plastic tank to increase this strength is problematic due to the difficulties in heating the cores, which are essential to produce the walls required for the baffle formation.

Besides, a solution containing urea, commercially known as Adblue, which is sprayed into the exhaust gas together with the fuel, is used to prevent environmental damage, especially in diesel and gasoline vehicles. This chemical is stored in a separate tank so that it does not mix into fuel. Two separate tanks, two separate carriage systems, brackets and straps are required for mounting on the vehicle. Two separate tanks and their separate carriage systems cause extra cost and weight and take extra volume on the tank in practice. Increase in weight of the vehicles means an increase in fuel consumption, in cost, environmental pollution and carbon emissions.

As a result, all the problems mentioned above made it necessary to research and make an innovation in the relevant technical field.

### SUMMARY

The present invention has been developed in order to eliminate the above-mentioned disadvantages and to bring new advantages to the relevant technical field, in order to produce a one piece vehicle tank with two chambers in rotation technology, which is not liquid permeable between each other, adhered to each other, and sturdy enough to pass the regulation tests applied in automotive sector.

The main object of the invention is to produce a one-piece plastic tank with rotation technology and at least two chambers in a single production step, with no liquid passage between them.

Another object of the invention is to bring the temperature of the cores placed in the mold rapidly and homogeneously to the same level with the other walls of the mold in order to create the wall and baffles separating the two separate chambers.

Another object of the invention is to provide a mold core heating system that increases energy savings and reduces carbon footprint in the shaping of materials in rotational molding.

Another object of the invention is that the heating of the core can be performed by various methods currently applied in rotation technology.

Another object of the invention is to accelerate the heating of the core with a heat pipe system with an electric heater at one end, thereby increasing efficiency.

Another object of the invention is to speed up the core heating by means of heat pipes which are heated by the air (convection) in the oven that is heated by gas or electricity, consequently increasing efficiency.

Another object of the invention is to bring the temperature in the core regions to the same level with the mold and bring the product wall thicknesses in the core regions to the same level with the wall thicknesses in the other parts of the mold.

Another object of the invention is that the wall between the two chambers of the product, in which liquid exchange between them is prevented, is designed to be resistant to vibration, thanks to a special design, where two walls are provided to kiss off each other at certain spacings with a special design.

To realize all the objects mentioned above and which will emerge from the following detailed description, the present invention is a combined fluid tank which is used in diesel engine vehicles using Adblue (an urea-based chemical) and manufactured using rotation technology from polymer-based material and comprising a first chamber and a second chamber positioned next to it, a double-walled impermeable chamber constructed between the first chamber and the second chamber, and a baffle located in at least one of the first chamber and the second chamber and which provides sound and vibration damping. Accordingly, the improvement is that said baffle and said wall comprise at least one core housing configured in conical form.

Another preferred embodiment of the invention is that the said core housings are in multiple numbers and are placed to be reverse-straight to each other respectively.

Another preferred embodiment of the invention is that the connection zones obtained by the kiss off method are constructed on the said wall and the baffle.

In another preferred embodiment of the invention, it comprises at least one passage gap defined, between the baffle that allows the movement of liquid between two baffles in at least one side surface of the fluid chamber.

Another preferred embodiment of the invention is that the wall thicknesses of all surfaces of the fluid chamber obtained is equalized within the tolerance of technology by transferring the ambient temperature to the inner surfaces of the core by using heat pipes.

To realize all the objects mentioned above and that will emerge from the following detailed description, a fluid tank manufactured using the rotation technology with a polymer-based material; a first chamber and a second chamber located next to it, a leakproof double-wall constructed between the first chamber and the second chamber; a method of manufacturing a fluid tank containing at least one baffle in it that provides sound and vibration damping. According to this the feature of the invention is including the following steps for structuring using the rotational method.
a) Placing the cores side by side at the mold so that the cores are positioned reverse-straight to each other.
b) Taking the polymer material to be shaped into the mold and applying heat to the mold and plastering the polymer material on the mold walls
c) Cooling the mold and removing the fluid tank from the mold.

Another preferred structuring of the invention is that in step (a), a heat pipe is placed on the cores as a tight fit.

### BRIEF DESCRIPTION OF THE DRAWINGS

FIG. 1 is a representative sectional view of the fluid tank.

FIG. 2 is a sectional view of the core housings.

FIG. 3 is a representative top section view of the fluid tank.

FIG. 4 is a representative view of the fluid tank.

FIG. 5 is a sectional view of the core housings.

FIG. 6 is a representative view of the alternative structuring of the baffle.

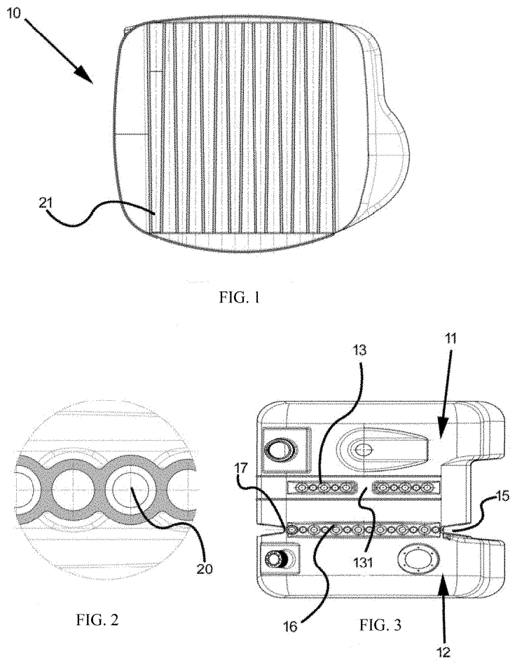

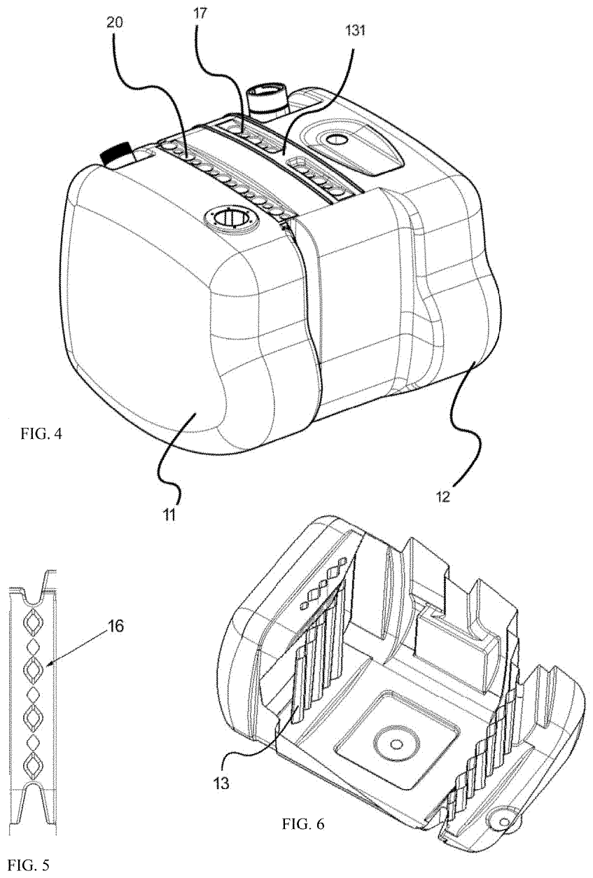

### REFERENCE NUMBERS GIVEN IN THE FIGS

10 Fluid Tank
11 First chamber
12 Second chamber
13 Baffle
131 Passage gap
15 Partition indent
16 Wall
17 Connection point
20 Core Housing
21 Core

### DETAILED DESCRIPTION OF THE EMBODIMENTS

In this detailed description, the invention is explained by examples of a fluid tank (10) formed by rotational molding, which does not constitute any limiting effect for a better understanding of the subject. The fluid reservoir (10) can be used for the fuel tank, water tank, or storage of any fluid.

Referring to FIG. 3; the fluid reservoir (10) includes a first reservoir (11) and a second reservoir (12). Said first chamber (11) and the second chamber (12) are in the form of a rectangular hollow prism-like. A double-layer wall (16) is constructed between the said first chamber (11) and the second chamber (12) to prevent leakage. Between the first chamber (11) and the second chamber (12) there is a partition recess (15), which is formed as a recess from the outside along at least two opposite surfaces, and between these two opposing recesses, said wall (16) extends.

The baffle (13) built on the fluid tank (10) and the wall (16) is obtained with cores (21) that are placed in multiple core housings (20) that are structured in accordance with rotation technology.

A single core (21) is placed in each core housing (20). Cores (21) and core housings (20) are configured in a conical-like form. The cores (21) are correctly placed at the tip of the core housings (20) where the diameter is narrower than the other larger diameter portion.

In this way, the removal of the cores (21) from the core housings (20) after the polymer material is formed is facilitated and accelerated. This is because, in the removal of the cores (21), only the separation of the tip parts from the narrow diameter part of the core socket (20) will be sufficient for the core (21) to come out, and the friction of the core (21) against the other walls of the core housings (20) is eliminated.

The core housings (20) are positioned side by side with each other in reverse-straight with each other, that is, next to the end part with a narrow diameter, with a wide outlet part. When the obtained fluid tank (10) is viewed from the outside, an image progressing in the form of a large diameter-narrow diameter-a large diameter-narrow diameter is obtained. Another advantage of using cores in this way is that the impact resistance of both the baffles (13) and the wall (16) is increased. In an application of the present invention, the baffle (13) is in cylindrical-conical form. In an alternative structuring of the invention, the baffle (13) is configured in a diamond-shaped cross-section and conical shape in a longitudinal section. And other alternative structuring of the invention, the baffle (13) can also be configured in different conical geometric forms.

In the preferred structuring, the diameter or diagonal of the wide mouth part of the cores (21) is in the range of 35 mm-50 mm. The diameter or diagonal of the narrow tip is between 25 mm and 35 mm.

With at least one heat pipe placed on the cores (21) as a tight fit, the baffle (13) and the wall (16) remaining inside the fluid tank (10) can be obtained. Heat pipes can receive heat by means of convection or radiation from the heat source created in the oven interior air, as well as by means of electrical heaters placed on the heat pipes as their integral parts.

In a structuring of the invention, in order to reduce the harmful effect of vibrations, at least one connection point (17) is defined at the kissing points called kiss-off in rotation technology between the double-layer wall (16) and the baffles (13). In the preferred structure, said connection points (17) are multiple.

The wall (16) is connected to the partition recesses (15) at the connection points (17) and thus acts as a monolithic, impermeable barrier between the first chamber (11) and the second chamber (12).

Although double-layer baffles (13) placed at the required places of the integral plastic fluid tank (10) to damp the acceleration and sound problems are associated with at least one surface of the first chamber (11) and the second chamber (12) it includes a space between at least one surface of the tank chambers (12) or a spacing (131) defining a passage gap between them.

Preferably, the baffles (13) are associated with at least two opposing surfaces of the first chamber (11) and the second chamber (12) to provide resistance against vibration. With the said passage gap (131), the movement of the liquid between the baffles (13) is provided to spread, thus allowing the suction pump of the tank to get fluid all the time.

Determining of which baffle (13) and/or intermediate wall that will have a connection point (17) will be made according to the results of the static and dynamic analysis to be made according to the vibration cutting, sound damping and tank volume and geometry.

When viewed from the outside after shaping, the connection points (17) are in the form of a plurality of conical grooves configured at spacings of a predetermined distance from each other. Between the two conical grooves is filled with polymer material. The grooves are in the geometry of the cores (21) and conical-like forms.

This structure, which provides sealing between the first chamber (11) and the second chamber (12), also provides damping the vibration, tension and sound occurring in the first chamber (11), the second chamber (12) and the baffles (13).

With the invention explained above in detail, it will be possible to avoid using two separate tanks for the fluid tank (10) and the Adblue tank, especially in diesel powered motor vehicles. Thus, there will be no need to use separate chassis connection and belt system for the first chamber (11) and the second chamber (12). Besides, space, weight and cost savings will be gained in vehicles. These gains reduce the carbon footprint, environmental pollution, and also provide fuel savings.

In particular, the invention comprises a first chamber (11) and a second chamber (12) located adjacent to it, which is used in diesel engine vehicles using Adblue (an urea-based chemical) and manufactured using rotation technology from polymer-based material; a double-layer and sealed wall (16) structured between the first chamber (11) and the second chamber (12); it relates to a combined fluid reservoir (10) comprising at least one baffle (13) positioned within at least one of the first chamber (11) and the second chamber (12) and providing sound and vibration damping.

The scope of protection of the invention is specified in the attached claims and it cannot be limited to what is explained in this detailed description for the sake of example. It is clear that a person skilled in the art can come up with similar structures in the light of the above, without departing from the main theme of the invention.

What is claimed is:

1. A combined fluid tank used with at least one partition, wherein the combined fluid tank is manufactured from a polymer-based material, the combined fluid tank comprises a first chamber and a second chamber positioned next to the first chamber, a double-walled impermeable chamber constructed between the first chamber and the second chamber, and a baffle located in at least one of the first chamber and the second chamber, wherein the baffle provides sound and vibration damping; wherein the baffle and a wall comprise at least one core housing configured in a conical form.

2. The combined fluid tank according to claim 1, wherein core housings are in multiple numbers and are structured to be reverse-straight to each other respectively.

3. The combined fluid tank according to claim 1, wherein connection zones obtained by a kiss off method are structured on the wall and the baffle.

4. The combined fluid tank according to claim 1, comprising at least one passage gap, wherein the at least one passage gap allows a movement of a liquid between two baffles and the at least one passage gap is defined between the baffle and at least one side surface of the combined fluid tank.

5. The combined fluid tank according to claim 1, wherein a wall thickness of surfaces of the combined fluid tank obtained by transferring an ambient temperature to inner surfaces of a core with a use of heat pipes is equalized within a technology tolerance.

6. A production method of the combined fluid tank of claim 1, comprising the following steps using a rotational method:
(a) placing cores side by side on a mold, and the cores are positioned reverse-straight to each other,
(b) taking the polymer-based material to be shaped into the mold and applying heat to the mold and plastering the polymer-based material on mold walls,
(c) cooling the mold and removing the combined fluid tank from the mold.

7. The production method according to claim 6, wherein in step (a), a heat pipe is placed on the cores as a tight fit.
